(19) United States
(12) Patent Application Publication
(10) Pub. No.: US 2015/0068886 A1
(43) Pub. Date: Mar. 12, 2015

(54) WATER DISTILLING APPARATUS USING SATURATED AIR CURRENTS AND METHODS FOR MAXIMISING THE PERFORMANCE THEREOF

(71) Applicant: TMW, Paris (FR)

(72) Inventors: Jean-Paul Domen, Vauchretien (FR); Stéphane Viannay, Saint Aubin De Luigne (FR); Olivier Boisdon, Saint Leger Des Bois (FR); Florian Dimeck, Angers (FR)

(21) Appl. No.: 14/389,940

(22) PCT Filed: Apr. 2, 2013
(86) PCT No.: PCT/EP2013/056964

§ 371 Date: Oct. 1, 2014

(30) Foreign Application Priority Data
Apr. 3, 2012 (FR) 12 00 985

(51) Int. Cl. C02F 1/04; B01D 3/42; B01D 3/32

(52) U.S. Cl. CPC C02F 1/043; B01D 3/32; B01D 3/4294; B01D 3/4211; C02F 2103/02
USPC 203/2; 202/158

(57) ABSTRACT

One of these distilling apparatus (10) comprises two columns, an evaporation column (14) and a condensation column (16), separated by a partition (18) equipped with rows of slits dividing them into 4 distillation stages. The evaporation column (14) comprises plates with hydrophilic or wettable faces, and the condensation column comprises rectangular hollow-plate (21) heat exchangers (22₁₋₆). Cold water ascends in these exchangers and saturated humid hot air descends in the condensation column (16). A perforated sheet (25₁₋₄) increases the uniformity of the partial airflows descending between the plates. The water is heated in a boiler (34); the hot water is scattered at the top of the evaporation column and the air cooled in the condensation column is sucked downwards by a fan (34). The air flows in a closed circuit. Performance is maximised, after the top temperature T_{E2} (45 to 90° C.) and the mass flow rate Q_{E0} of the scattered water have been set, by adjusting the mass flow rate Q_{A1} of the sucked dry air in order to give the temperature T_{A} of this air a preset value at the top of the lowest evaporation chamber. Next, the effective cross sections of the partition apertures are adjusted in order to bring the air exiting from the evaporation chambers of higher rank to other preset temperatures T_{A2} to T_{AN}, the enthalpy curves of the air deviating from flat by <1.5° C. Next, the effective cross sections are corrected in order to make the temperature of the air at the entrance of an evaporation chamber equal to the temperature at the exit of the condensation chamber of the same rank. The performance coefficient (PCo) of the apparatus may be >6, with a satisfactory flow rate of distilled water. Applications: production of fresh or very high purity water; production of concentrated industrial wastewater; production of high-concentration ethanol, acids or bases.

The invention relates to both improved water distillation apparatuses of the type using streams of forced saturated damp hot air and recovery of latent heat of condensation, and methods to maximize the performance thereof. Applications of these distillation apparatuses include desalination of seawater and, more generally, demineralization of any clear water, especially for producing ultra-pure water. The invention also relates to the concentration of various industrial aqueous solutions, to be transformed (food industry) or destroyed (polluted effluent waste) and the separation of certain volatile liquids from their aqueous solvent (ethanols, acids, bases . . . ).

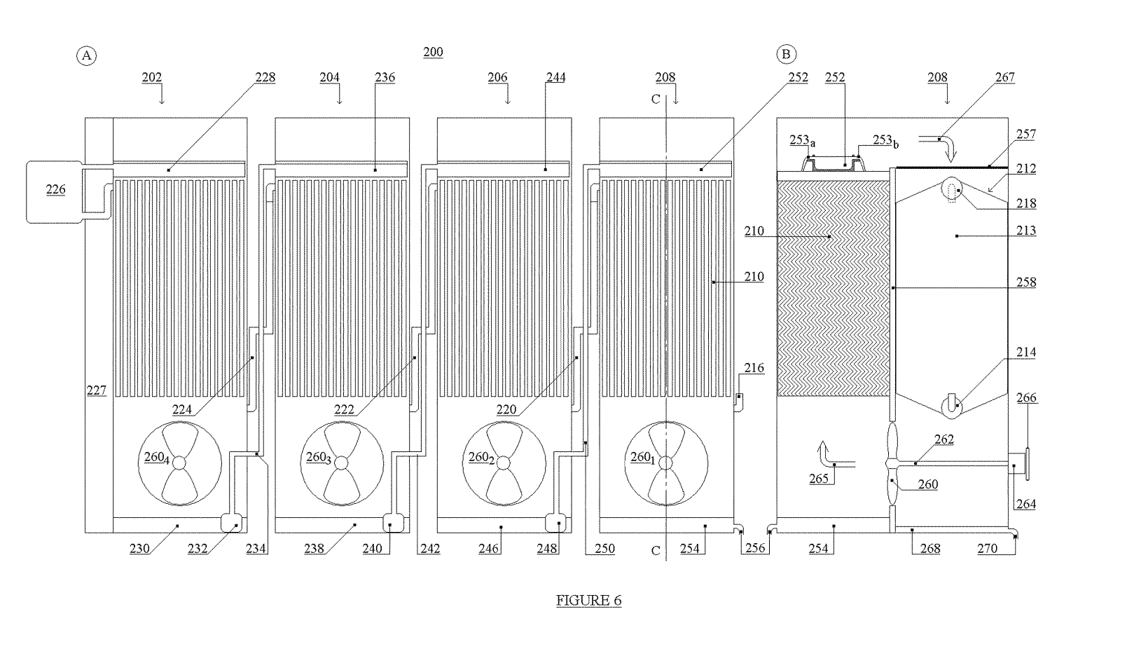

Two water distillation apparatuses, using streams of forced saturated damp hot air with recovery of latent heat of condensation are described and commented on (1) in FIG. 5 of a French patent application of 1975, published under No. 2,281,896, and (2) a U.S. Pat. No. 3,860,492 of the same year.

In the water distillation apparatus of this French patent application,
three distillation stages are arranged one on top of the other;
each distillation stage includes a pair of chambers, one for evaporation and the other for condensation, an upper portions of these chambers communicating by a duct;
the ducts of the two lower distillation stages include manual means for adjusting their port cross-sectional area;
the three evaporation chambers are filled with wettable artificial nuts loosely packed;
the three chambers include three condensing coils connected in series;
means are connected to the apparatus to circulate a stream of water at a low initial temperature from bottom to top in the three condensing coils of the condensation chambers;
a water heater is connected to an upper portion of the condensing coils to bring the exiting water to a high temperature of 95° C.;
means for distributing and spreading are installed above an upper evaporation chamber to spread this water at high temperature over an upper portion of this chamber;
a fan is installed at a lower portion of a lower evaporation chamber, to force saturated damp hot air flow rates to flow from the bottom to the top in all three evaporation chambers and from top to bottom in the three condensation chambers, in order to cause air streams circulating up of the evaporation chambers to acquire predetermined temperatures;
means are provided for collecting the distilled water and the concentrated aqueous solution, respectively installed at a lower portion of a lower condensation and evaporation chambers.

This water distillation apparatus has been arranged to form these three distillation stages in order to improve heat exchange between streams of hot water and hot air or air and water circulating in opposite directions, taking place in the evaporation chamber and the condensation chamber of the apparatus. Such a solution (not justified in the document) is indeed necessary because, depending on the temperature, the heat capacity Cp_{E} of one kilogram of water is constant (4.18 kJ/K), while the apparent heat capacity Cp_{A} of one kilogram of dry air at standard pressure, incorporated into saturated hot damp air, increases with temperature and exhibits a hyperbolic branch which tends to infinity at 100° C. With three stages of distillation, the pair of curves representing the enthalpy fluxes of rising and descending air is transformed into two sequences of three festoons. In these conditions, we greatly minimize the variation between, on the one hand, these two series of festoons and on the other hand, the two parallel straight lines representative of the enthalpy flux of the water flowing upwardly and downwardly. The total heat exchange thereby achieved is much higher than it would have been with a single distillation stage and the amount of distilled water produced is, under these conditions, greatly increased. But the performance of such water distillation apparatus is nevertheless far from maximal.

Indeed, in this water distillation apparatus, with a stream of air at initial temperature T_{A0}=20° C. and a stream of water at a temperature T_{low} of T_{E0}=20° C. and T_{high} of T_{E2}=95° C., we have, at an upper portion of the three stages of distillation of ranks 1 to 3, for air circulating in an open loop: T_{A1}=55° C., T_{A2}=75° C., T_{A3}=90° C., and 35° C. at the lower portion of the condensation column. For water circulating in open loop, at the lower portion of the three evaporation chambers we have, from top to the base of the evaporation column: T_{E2}, 85° C., 65° C. and T_{E3}=40° C. At an upper portion of the three condensation chambers we have, for the water, from the base to an upper portion of the condensation column: T_{E0}, 45° C., 65° C. and T_{E1}=75° C. Under these conditions, the coefficient of performance (CoP) of the apparatus (the ratio between the thermal energy used in distillation and the thermal energy supplied by the water heater), CoP=(T_{E2}−T_{E0})/(T_{E2}−T_{E1})=3.75, which is an average value, acceptable when the energy used is cheap. But the question is, is this calculated coefficient of performance (CoP) possible with the apparatus described?

To look into this, we will look more closely at the temperatures announced for the air and water. And we will see that these temperatures (clearly not experimental) are not suitable for producing average performance and a fortiori, high-performance, both from a technical and an economic point of view. This firstly is the case for the air temperatures at an upper portion of the evaporation chambers and at the lower portion of the condensation chambers of the three distillation stages.

Initially, what is involved is choosing the two intermediate air temperatures T_{A1} and T_{A2} at an upper portion of the evaporation chambers of rank 1 and 2. This choice is usually made starting out from extreme air temperatures: a low temperature T_{A0} imposed by the ambient air and a high temperature value T_{A3} relatively close to T_{E2}, the high temperature of the water distributed at an upper portion of an upper evaporation chamber. As a result of the three distillation stages provided in the distillation apparatus, the curve which it is desired to represent the corrected enthalpy fluxes of the ascending saturated hot damp air streams in the three evaporation chambers is an ideal sequence of three segments of a straight line of slopes A=ΔH/ΔT, with ΔH and ΔT the increases in enthalpy flux and air temperature in each of the evaporation chambers. In fact, the actual curve representing the corrected fluxes is constituted by three festoons which depart from a straight line and which meet angularly at two points. The maximum difference between these two curves, actual and optimal, is the degree of deflection ΔT_{F} of each festoon. For each festoon, the value in degrees of the deflection ΔT_{F} is the quotient ΔH*/A where ΔH* is the difference in enthalpy flux between the middle of the ideal line and the point on the curve for air enthalpy flux at the mean temperature of the chamber. In the case of extreme temperatures of saturated damp hot air in an upper portion and lower portion of the evaporation chambers, announced in the patent concerned, namely 30 (approximately), 55, 75 and 90° C., the values of enthalpy flux for 1 kg/s of dry air, carried away by the stream of saturated damp hot air ascending in each evaporation chamber are given by the table for specific enthalpy H of the saturated damp hot air. For significant temperatures of the damp air (middle and ends of the straight line segments), we have H₉₀=3887 kW; H_{82.5}=1864, H₇₅=1088; H₆₅=600; H₅₅=353; H_{42.5}=179 and H₃₀=100 kW. For the lower festoon, we have ΔH₁*=½ (H₅₅+H₃₀)−H_{42.5}=48 kW and A₁=(H₅₅−H₃₀)/25=10 kW/K, so that ΔT_{F1}=4.8° C. For the central festoon we have ΔH₂*=120 kW, A₂=37 kW/K and ΔT_{F2}=3.2° C. For the upper festoon we have ΔH₃*=623 kW, A₃=187 kW/K and ΔT_{F3}=3.3° C. All these values are unacceptable, for the reason that they are too high. But as the deflection ΔT_{F1} of the lower festoon is the most significant, it is, therefore, the only one to be taken into account for determining (T_{E2}−T_{E1}). Here, it represents a quarter of the temperature increase required of the water heater, which leads to a corresponding reduction in coefficient of performance (CoP) of the apparatus. By way of conclusion of these initial comments, we see that for water distillation apparatus to be efficient, the number of distillation stages and the choice of air temperatures at an upper portion of the evaporation chambers cannot be determined in an arbitrary fashion even if this does seem to be in line with common sense.

As regards temperatures at the lower portion of condensation chambers, there is no reason for the temperature of the air stream deviated by the two communication paths between the evaporation and condensation chambers of ranks 1 and 2, and the temperatures of the descending air streams in condensation chambers of rank 2 and 3 to be the same. Indeed, as the architecture of the two chambers of a distillation stage is different one from the other, then a priori, their respective heat exchange coefficients are also different. The inequality of these temperatures causes a decrease in coefficient of performance (CoP), if it is not corrected.

In addition, as the shape and dimensions of the cross-sections of the ducts discharging into the condensation chambers, nor the shape of the cross-section of these chambers are not specified, the exact conditions under which air streams deviated by these ducts enter these chambers and mix with the air streams descending from chambers of higher rank is not known. Whatever the case may be, streams of air which actually come into close contact with the coils are, a priori, in very small minority compared to those which do not. This is at the origin, locally, of air/water thermal couplings which are unbalanced and very different one from the other. Overall, the saturated damp hot air is very poorly cooled and vapor is very badly condensed in the condensation chambers equipped with condensing coils. For this to be otherwise, it is necessary that the surface area per unit volume S/V for heat exchange at these coils be relatively high in the condensation chamber. As such a ratio for efficient heat air/water exchange is S/V>150 m²/m³, we can see that this is inconceivable when using conventional zigzag or spiral coils, for which S/V<10 m²/m³. The situation is better when multiple coils or sections of coils are assembled in parallel, with upstream and downstream manifolds. This is something which the cited document does not suggest. In any case, the thread-like structure of conventional coils often leads to unacceptable pressure loss in the water stream. In addition, their cost is often prohibitive since, being a priori of metal, their metal must be insensitive to the corrosive action of seawater The conclusion of these discussions is simple: conventional metal coils are completely unsuitable to fulfil the double function assigned to them in high performance (coefficient of performance (CoP>4) water distillation apparatus, namely: efficiently heat up an ascending seawater stream using a descending stream of saturated damp hot air and condensing the maximum amount of water vapor carried by the air stream under satisfactory economic conditions for the relevant markets.

Moreover, packing wettable artificial nuts into the evaporation column leads to significant pressure losses in the air stream blown in by the fan installed at a lower portion of this column. This leads to a requirement, for the air stream, for relatively high pressures and high local velocities, which inevitably leads to the presence of droplets of brine in air streams entering into the condensation column. In the case of water distillation apparatus treating standard seawater, this leads to the presence of a 1 to 2 g salt content per liter of distilled water produced, making consumption thereof unpleasant. In the case of water distillation apparatus treating polluted industrial water, discharge of which is prohibited, the situation is worse: the distilled water remains polluted and discharge thereof is prohibited.

To complete the discussion of the problems posed by water distillation apparatus disclosed in the cited document, we can still note that the temperature T_{E2}=95° C. provided for the hot water to be distributed at an upper portion of the evaporation column, is a temperature which is too high, in the long run dangerous because it accelerates the precipitation of certain salts dissolved in the water and, as a result, leads to significant limescale deposits within the passages taken, causing disruption and, in the long-term, these finish by blocking the operation of the machine.

The water distillation apparatus according to U.S. Pat. No. 3,860,492 is designed to be an automatic system for concentrating industrial water. It includes a first distillation stage, materialized in a lower half of the two columns, and an indeterminate number of stages arranged thereabove. The wettable components of the evaporation column consist of suspended netting and the hollow heat exchange components of the condensation column are condenser coils. The majority of the above negative remarks apply. In addition, arrow of the festoon of the air enthalpy curve in this first stage is, a priori, notably greater than that in the case discussed above. Higher performance distillation apparatus using eight stages is additionally envisaged, without further details.

To conclude the commentary on these two documents, we can affirm that one major condition to insure the process involved does exhibit high energy performance is that the difference in temperature between the damp air and the water be as small as possible throughout the length of the evaporation and condensation columns. The fact of splitting up each column into several stages, where the damp air flow rates are different and the water flow rate is practically constant already makes possible an overall reduction in the difference in temperature between the damp air and the water. The two documents cited do propose such a solution. The French patent does not give an explanation. The US Patent gives a partial explanation starting from the curve showing the evolution of saturated damp air enthalpy as a function of temperature. But neither of these two patents deals with a way of minimizing the difference in temperature between the damp air and the water within each one of the stages.

Accompanying this major condition there is another condition which is just as important: thermal exchange coefficients which notably result from thermal exchanges in dry air, the mechanism for distributing water vapor into the air and the surface area per unit volume (S/V) of the components of the distillation units, must be as high as possible, in order to be able to sufficiently reduce this difference in temperature between the damp air and the water. But this is all the more difficult when we consider that obtaining good mastery of heat exchanges in saturated damp air is something which is not at all obvious.

The first subject matter of the invention concerns various improved water distillation apparatuses, using forced saturated damp hot air streams with recovery of the latent heat of condensation, including several distillation units adapted to operate under optimal conditions.

The second subject matter of the invention concerns such improved water distillation apparatuses in which, through construction, these optimal conditions are, within the condensation chambers, established by the use of components having a very high thermal exchange coefficient.

The third subject matter of the invention concerns such improved water distillation apparatus in which these optimal conditions, in both chambers of each distillation unit, are established by differences in temperature between the damp air and the water which are as low as possible.

The fourth subject matter of the invention is the realization of such improved water distillation apparatus having a high and/or variable capacity for daily production of distilled water, constituted by modular distillation units which are easy to construct, install and operate.

A fifth subject matter of the invention concerns methods for maximizing the performance of these various water distillation apparatuses.

A sixth subject matter of the invention concerns the construction of such improved water distillation apparatuses which are suitable for demineralizing water, notably desalinated seawater, concentrating industrial waters and separating volatile liquids from their aqueous solvents, with a high energy yield.

In accordance with an enlarged definition of the water distillation apparatus disclosed in the French patent commented on above, the present distillation apparatus is of the type in which:
a number N of distillation units is provided, the unit of rank 1 being the least hot and the one of rank N being the hottest;
each of these N distillation units includes a pair of vertical chambers, one for the evaporation of water and the other for vapor condensation, communicating at an upper portion;
each of the N evaporation chambers is occupied by a set of wettable or hydrophilic components;
each of the N condensation chambers is occupied by a hollow heat exchanger device, these N devices being connected in series;
means are connected to the apparatus to provide a water stream, at a mass flow rate Q_{E0}, at a low initial temperature T_{E0}, to cause the water stream to flow upwardly in the N hollow heat exchange devices;
a water heater is connected to the outlet of the N hollow heat exchange devices, to bring the stream of water exiting therefrom at a temperature T_{E1} up to a high temperature value T_{E2} lower than 100° C.,
means are installed in the apparatus to spread the hot water at a temperature T_{E2}, at an upper portion of the components of an evaporation chamber of rank N and to cause it to trickle down the components of evaporation chambers of lower rank;
means are installed in the apparatus for forcing N adjusted saturated damp hot air flow rates to circulate upwardly in the N evaporation chambers and downwardly in the N condensation chambers so as to respectively bring the N streams of air, circulating at an upper portion of the evaporation chambers, up to predetermined temperatures T_{A1} to T_{AN};
means for collecting distilled water flow rates are installed at a lower portion of the condensation chamber of rank 1;
means for collecting flow rates of concentrated aqueous solution produced are installed at a lower portion of the evaporation chamber of rank 1.

According to the invention, the improved water distillation apparatus of the broad type defined above is characterized in that:
the N heat exchange devices have cross-sections and heights substantially identical to those of the N condensation chambers;
the N heat exchange devices are groups of hollow polymer plates assembled so as to be separated at a constant pitch, each group being provided with upstream and downstream manifolds;
in the N condensation chambers, the hollow plates are installed vertically.

According to the invention, such water distillation apparatus is further characterized in that it includes N perforated trays adapted to distribute total flow rates of air, respectively entering into the N condensation chambers, into substantially equal partial air flow rates penetrating into the spaces between the hollow plates of these chambers.

According to the invention, such water distillation apparatus is more precisely characterized in that in each of the N distillation units:
communication between the evaporation and condensation chambers includes a horizontal elongated rectangular window;
the cross-sections of the condensation chamber, perforated tray and hollow plates are all rectangular;
the perforated tray is installed without significant edge portion leakage and has rows of holes, surmounting all the hollow plates;
said holes are oblong and are formed at the same pitch as that at which the plates are assembled, their width being substantially equal to that of the spaces between the plates.

These simple provisions are both novel and non-obvious, since they provide practical solutions to concrete non-obvious problems, considering they were overlooked and/or not expressed until now. Firstly, the choice of condensation chambers having a rectangular cross-section is not the only one possible but, clearly, the most rational choice considering that the heat exchange device is constituted by an assembly of rectangular hollow plates, which are the only ones which are currently available on the market. With condensation chambers which have a non-rectangular cross-section, the arrangement of the hollow plates will be done on the basis of the specific geometry or geometries, which the manufacturer has given these plates.

With a horizontal rectangular entrance window, according to the invention, the stream of saturated damp hot air which penetrates into the condensation chamber of each one of the N distillation units, does this in the form of uniform horizontal and parallel veins of air which have overall, an elongated rectangular cross-section (40×10 cm, for example). Under these conditions, in the distillation unit of rank N, such veins of air can correctly spread out above the heat exchange device which is occupying the whole cross-section of the condensation chamber (40×30 cm, for example). In the other units, the two flow rates, the horizontal one and vertical one, which enter into the condensation chamber at the same temperature (below it will be seen why and how this is so) but the mixing thereof sets up disordered movements and excess pressures.

The perforated tray, which is installed without notable lateral leakages, corrects the potential action of these disordered excess pressures, by forcing the total air flow, entry into each condensation chamber, to be redistributed into substantially equal partial flow rates, which penetrate into the spaces separating the vertical hollow plates of the heat exchange device.

Using condensation chambers having a rectangular cross-section and rectangular hollow plates which are assembled at a constant pitch, the perforations of the perforated tray are rows of oblong holes, having the same pitch as these plates. Within each condensation chamber of rank 1 to N, equality of the partial flow rates of air circulating between the plates is a result of the substantial drop in pressure Δρₙ₌½ρₙvₙ², which is created during their passage through the holes (ρₙ being the density of the saturated damp hot air entering into the chamber of rank n, and vₙ is the velocity at which it passes through the holes). As a consequence, the surface areas, both total and individual, of the oblong holes of the perforated distribution and spreading plate of each condensation chamber can be determined further to a simple calculation, done using the total flow rate of incoming air, which itself is calculated, as will be seen below. Additionally, it is possible to replace each row of holes by one or a plurality of slots of an appropriate calculated width, but the distribution of the partial air flows circulating between the hollow plates is in this case less uniform and, inside the condensation chamber, the heat exchange performed is less effective, but generally satisfactory.

Thanks to the arrangements according to the invention, effective heat exchange is performed between, on the one hand, the descending (3 to 6 mm thick) layers of saturated damp hot air, sweeping both faces (30×40 cm for example) of the (4 to 6 mm thick), thin-walled (<1 mm) hollow plates of polymer material and, secondly, the narrow (2 to 4 mm) thicknesses of water which is ascending inside these plates. This is achieved despite the relatively high thermal resistivity of polymer materials. The coefficients of heat exchange and conductance between these air and water streams are significant since they are spread over two relatively large faces of this plurality of thin-walled hollow plates, assembled close to each other, occupying the whole volume of a condensation chamber. This is possible since the surface area per unit volume of the heat exchanger using separated, assembled hollow plates can reach S/V=250 m²/m³, when plate pitch is 8 mm. Thermal conductance here is several tens of times greater than that produced between an air stream which is passing through a condensation chamber occupied by a conventional metal coil, whether this be in zigzag or helical, and the water conveyed therein.

Further, if we do replace these conventional coils of 1975 by their current up-to-date versions, in other words bundles of polymer material tubes, having upstream and downstream manifolds, the surface area per unit volume of such a bundle, (depending on the manufacturer, 15<S/V<110 m²/m³), remains on average three times less than that of a group of assembled hollow plates. If one were to replace the hollow plates by such bundles of tubes, this would lead, on average, to tripling the thicknesses of air and water, and consequently substantially diminishing thermal conductance per unit volume. A further significant and non-obvious comparative advantage of heat exchangers using hollow plates, installed in the condensation chambers of water distillation apparatus will be discussed below, in relation with the temperatures and flow rates of the saturated damp hot air streams inside these chambers.

In addition to these initial advantages specific to hollow plates of polymer material, there is the further advantage provided by the perforated tray according to the invention, in other words the division of the total air flow rate of incoming air in each condensation chamber into substantially equal partial flow rates that circulate between the hollow plates. When it is desired to maximize performance of the apparatus, it is essential to ensure that these partial flow rates are the same. In effect, simple calculation shows that a moderate disequilibrium (<20%) between these partial air flow rates would result in a division by up to two of the efficiency of heat exchange achieved, and consequently of the performance of the apparatus. And this all the more so when we consider when we are seeking a target coefficient of performance which is even higher. As a consequence, thanks to these initial provisions according to the invention, in water distillation apparatus improved in this way, the effective heat exchange achieved inside the condensation chamber of each distillation unit leads to a maximum condensation of vapor and a maximum heating up of the water.

Further, experience has shown that with oblong holes in the perforated tray, having a width which is substantially equal to the distance between two hollow plates (>3 mm), we eliminate the risk of these holes becoming blocked by droplets of condensed water. Additionally, each partial air flow rate exiting from a hole is efficaciously distributed between two plates, when there is a distance of less than about 10 cm separating two rows of holes of a perforated tray.

According to the invention, a method for maximizing the performance of these water distillation apparatuses according to the invention is characterized in that, depending on the conditions of use of the apparatus, it includes the following preliminary steps:
select an appropriate value for the mass flow rate Q_{E0} of the water to be treated and a high temperature value T_{E2} between 45 and 90° C. for the water to be distributed at the upper portion of evaporation chamber of rank N, then take the initial low air temperature T_{A0} and water temperature T_{E0};
select an apparatus having a number N of distillation stages which is at least 3 and a maximum of 6, determined as a direct function of the values of the differences (T_{E2}−T_{E0}) or (T_{AN}−T_{A0}) between the extreme temperatures of the air or water, the number N=4 being suitable for all cases;
select N approximate optimal predetermined temperatures T_{A1} to T_{AN}, which the air streams at an upper portion of the N evaporation chambers should adopt whereby the departures from a straight line of the N festoons of the enthalpy curves for saturated hot damp air rising in these N evaporation chambers, have satisfactory reduced amplitudes, and which are more or less equal;
calculate the N approximated mass flow rates of dry air Q_{A1} to Q_{AN} and then the N approximated volume flow rates of saturated damp hot air Q_{S1} to QS/V, respectively circulating in the N distillation units of the apparatus.

Through the choice of a temperature T_{E2}<90° C. for the hot water to be distributed and spread, scaling of components of the apparatus is minimized. The choice of the value T_{E2}, between 90 and 45° C., depends on the primary heat source available (solar, thermal engines, hot effluent, burners . . . ) and, where applicable, the temperature of boiling of the volatile liquid (ethanol, acid, base) dissolved in the water that is to be separated from the solvent.

To implement the various arrangements of the method according to the invention, we first make use of the table for enthalpy of saturated damp hot air. We saw earlier that the deflection of a festoon which departs from a straight line in a particular evaporation chamber is the difference in degrees, which corresponds to the maximum difference in watts between the curve representing the actual value of the enthalpy flux of the saturated damp hot air, and the deflection it would have if the curve was a straight line segment. Appropriate software makes it possible to draw up a digital chart for the amplitudes of these N festoons which depart from a straight line for every pair of extreme temperatures (T_{A0}, T_{AN}) used for the air stream rising in the evaporation column. In a four-distillation-stage distillation apparatus, with an upper water temperature value of T_{E2}=85° C. and extreme air temperatures of T_{A4}=83° C. and T_{A0}=33° C., the approximated optimum temperature of the air at an upper portion of the evaporation chambers of rank 1 to 3 are substantially: 47.5°, 61° and 73° C. In this case, the four increments ΔT_{A1} to ΔT_{A4} between the extreme temperatures of the air in the evaporation chambers are, from top to bottom, 10, 12, 13.5 and 14.5° C., while the departures from a straight line of the festoons are substantially equal to 1.2° C. (to which there should be added an imposed 0.5° C. deviation due to the salinity of the water). If we increase the number of distillation stages, departure from a straight line or deflection of the festoons decreases, but below about 0.5° C. for these deflections, increasing the number N is of little value. In an improved water distillation apparatus according to the invention, the optimal number of distillation stages may range from N=3 to N=6, as a function of the difference between the extreme temperatures of the air (T_{AN}−T_{A0}), ranging from 35 to 65° C. In practice, the number N=4 is suitable in all cases, for technical and economic reasons.

Within the four evaporation chambers, the temperatures T_{A1} to T_{A4} as well as the increments ΔT_{A1} to ΔT_{A4} being established, the heat capacities Cp_{A1} to Cp_{A4} of the saturated damp hot air, at the average temperatures Tₘ₁ to Tₘ₄ in these chambers are known. Enthalpy fluxes exchanged in an evaporation chamber of rank n are: ΔH_{Aη}=Q_{An}. Cp_{An}. ΔT_{An} and ΔH_{En}=Q_{EN}. Cp_{En}ΔT_{En}. As increments ΔT_{An} and ΔT_{En} are substantially equal and Q_{En} only slightly differs from Q_{E0}, the approximated mass flow rate of dry air in a stage of rank n is substantially Q_{An}=Q_{E0}. C_{pE}/Cp_{An}. Tables giving the density of saturated damp hot air make it possible to know the approximate volume flow rates Q_{S1} to Q_{S4} of this hot air, at average temperatures Tₘ₁ to Tₘ₄ in the four evaporation chambers. From these values, it is easy to calculate, for each condensation chamber, total and individual surface areas of the holes in the perforated tray and the pressure drop to be generated by the presence of the distribution plate.

For example, with Q_{E0}=100 g/s and in the evaporation chamber of rank 1, Tₘ₁=41° C., Cp_{A1}=8.74 kW/kg·K, Q_{A1}=47.8 g/s, we get Q_{S1}=43.9 dm³/s. In the evaporation chamber of rank 4, with Tₘ₄=79° C. and Cp_{A4}=102.6 kW/kg·K, we get Q_{A4}=4.1 g/s and Q_{S4}=4.92 dm³/s. These two very different flow rates indicate that the air flows in the condensation chambers of ranks 1-4 have progressively shifted from a turbulent regime to a laminar regime. This leads to very different surface areas for the holes in the distribution plates of ranks 1 to 4. Moreover, this leads to an unobvious additional justification for the exclusive use of heat exchangers having hollow plates in the water distillation apparatus according to the invention.

Indeed, in the case of dry air, thermal exchange coefficients depend on:
the velocity of the air (exchanges increased with speed);
a characteristic dimensions of the exchanger (the smaller this dimension is, the greater the exchanges): in the case of an assembly of hollow plates, it is the thickness of the air channel between two plates; for a bundle of tubes, it is the diameter of the tubes; and, in general terms, channel thickness is considerably smaller than the diameter of the tubes;
the physical characteristics of the air (viscosity and thermal conductivity) which depend slightly on temperature.

In the case of hollow plates, below a certain airspeed, flow changes from one regime to another (from turbulent, it becomes laminar) and the coefficient of exchange no longer depends on velocity but remains relatively high since the characteristic dimensions is small. This is not the case when we are dealing with bundles of tubes, where the transition from one flow regime to another is less sharp and the characteristic dimension is larger than in the case of plates.

With saturated damp air, operating under an evaporation or condensation regime, the apparent thermal exchange coefficient depends on the exchange coefficient for dry air defined above but, additionally, the diffusion mechanism which intervenes in the evaporation or condensation process considerably amplifies this exchange coefficient, and the coefficient of amplification is substantially proportional to the rate of increase in saturated vapor pressure as a function of temperature. As a consequence, in the hottest condensation chamber of the distillation apparatus (rank N), where the equivalent flow rate of dry air (and consequently its speed) is small, a heat exchanger using hollow plates will have significantly better performance than one using a bundle of tubes; and this will be increasingly true as the surface area per unit volume S/V increases. The same will apply more or less for the condensation chambers which are cooler of the distillation apparatus.

According to the invention, water distillation apparatus of the type in which:
the N distillation units are located one on top of the other, forming two evaporation and condensation columns;
and a fan is installed at a lower portion of the evaporation column;

is characterized in that:
the N evaporation chambers include thin planar supports, having wettable or hydrophilic surfaces installed vertically at a constant pitch;
the N communication paths between pairs of chambers are N horizontal rows of vertical slots, with the same pitch as the preceding one, formed in a partition separating the two chambers:
fan control is preset and the respective cross sections of passage of the rows of slots are fixed,
the setting of the fan control and the cross-sections of the slots have been established in accordance with design specifications arising from final manual adjustment of the first piece of apparatus of a series of identical water distillation apparatuses.

In an alternative embodiment, in water distillation apparatus of the type in which:
the N distillation units are located one on top of the other, forming two evaporation and condensation columns;
the N evaporation chambers are filled with artificial nuts which are wettable, loosely packed,
a fan is installed at a lower portion of the evaporation column;

it is characterized in that:
the N communication paths between the pairs of chambers are ducts of rectangular elongate section, having upstream a perforated horizontal area, adapted to retain said nuts and to allow air to pass, and having downstream, said horizontal elongated rectangular window;
in each of the N ducts, there is installed a droplet separator, arranged immediately downstream of the perforated area followed by a partition with a horizontally elongated rectangular slot;
control of the fan is preset and the respective widths of the N horizontal slots are fixed,
the setting of this fan control and the widths of the slots have been established in accordance with design specifications, resulting from final manual adjustments of the first piece of apparatus of a series of identical distillation apparatuses.

According to the invention, a method to maximize performance of the first of a series of one or the other of these two distillation apparatuses includes the following additional steps:
adjust the fan speed to cause the volumetric flow rate of saturated damp hot air Q_{S1} previously calculated to circulate in closed or open loop in the distillation stage of rank 1, in order to raise the temperature of this stream of air at an upper portion of the evaporation chamber of this stage, to the optimal approximate predetermined value T_{A1};
successively adjust the adjustable cross-sections of the communication paths established between the evaporation and condensation chambers of the distillation stages of ranks 1 to (N−1), to respectively bring the temperatures of the air streams at an upper portion of the evaporation chambers of distillation stages of ranks 2 to N, to the predetermined approximate optimum values T_{A2} to T_{AN};
maximize the temperature T_{E1} of the water leaving the condensation column, in order to determine constructional specifications for the fan and for these (N−1) port cross-sectional areas, (a) by making respectively equal the temperatures T_{A1} to T_{A(N-1)} of the saturated damp hot air streams, entering the evaporation chambers of distillation stages of ranks 2 to N, and the temperatures T_{A1*} to T_{A(N-1)*} of the saturated hot damp air streams leaving the condensation chambers of these same distillation stages, by means of slight correction of the previously adjusted port cross-sectional area of the (N−1) communication paths; and (b) by readjusting the air flow rate previously produced by the fan, in particular by a small correction of a frequency of the supply voltage of the motor, when it is of the synchronous type.

The implementation of the method according to the invention can begin as soon as the number N of stages of distillation and the N temperatures T_{A1} to T_{AN} have been selected, as soon as the hot water has been distributed and spread for a certain amount of time (>1 hour, in view of the thermal inertia of the apparatus), the fan is causing the air to circulate in an open or closed loop, and the partition openings are half closed. This first adjustment is terminated as soon as the intended temperature T_{A1} is reached. The mass flow rate of dry air Q_{A1}, included in the flow rate of air supplied by the fan, is now, just like T_{A1}, at an approximated optimal value. When circulation is taking place in a closed loop, the temperature T_{E0} of the cold water and the initial state of the port cross-sectional areas of the openings in the partition determine the initial low-temperature T_{A0} of the air. In this case, T_{A1} is a provisional predetermined temperature, obtained at the end of this first adjustment step for the flow rates of the air streams circulating in the evaporation chambers.

The second step in the method according to the invention employs means for adjusting cross-sections for air passage. We start with the lowest opening in order to adjust the temperature T_{A2} of the air stream in the upper portion of evaporation chamber of rank 2. Once this adjustment has been done, we do the same for the evaporation chambers of increasing rank from 3 to N. The operation is restarted at least one second time in order to correct variations in the temperatures T_{A1} to T_{AN} inevitably brought about by the successive adjustments, since the mass flow rates of dry air Q_{A1} to Q_{AN} and their temperatures T_{A1} to T_{A1} are independent. In the case of closed-loop air circulation, the low temperature T_{A0} of the air being blown in at the lower portion of the evaporation column becomes progressively closer to T_{E0}, the initial water temperature.

The third step in the method according to the invention has the aim of respectively bringing to equal temperatures, the temperatures T_{A1} to T_{A(N-1)} and T_{A1*} to T_{A(N-1)*} of the layers of air circulating at the lower portion of the evaporation and condensation chambers of the (N−1) highest superposed distillation stages. When the air temperature, at the lower portion of a condensation chamber of a given rank is different to that of the lower portion of the evaporation chamber of the same rank, it is not known whether the mass flow rate of dry air concerned, Q_{A1} to Q_{AN} at that point is a bit too high, or too low. In practice, we start with the highest stage and increase or reduce the flow rate of air circulating in the evaporation chamber of rank N, by slightly and carefully increasing or decreasing the port cross-sectional area of the communication path between the chambers concerned. It is necessary to wait a short while to see whether this action has resulted in the two temperatures concerned coming closer together. If this is the case, one continues up until the point where they are equal. Otherwise, one does the opposite. If this is not sufficient to obtain the desired equality, the best adjustment is noted and this is supplemented by adjusting the port cross-sectional area of the communication path delimiting the upper portion of the distillation stage of rank (N−1) up until this equality of temperatures is found. One then proceeds in the same fashion for this distillation stage of rank (N−1), adjusting the port cross-sectional area of the opening delimiting the stage of rank (N−2) and then returning to the two openings of higher rank, in order to maintain temperature equality at the bottom portion of the evaporation and condensation chambers of the distillation stages of ranks (N−1) and N. The procedure is renewed for all the stages of lower rank, up to the stage of rank 2. Next, it is a priori necessary to adjust the air flow rate produced by the fan in order to maximize T_{E1}, the water temperature at the outlet from the condensation column.

With air circulating in a closed loop, we will have finally minimized as much as possible the temperature of the air T_{A0}* in the lower portion of the condensation column by causing it to approach T_{E0}, the temperature of the water entering therein and, at the same time, we will have maximized as much as possible the temperatures T_{AN} of the air and T_{E1} of the water at the top portion of this column, by bringing both of them close to the temperature T_{E2} of the water being distributed and spread. The air temperatures at the lower and upper portion of the distillation stages would then have optimal set point values T_{A0C} to T_{ANC}, slightly different to the initial theoretical optimal temperatures T_{A1} to T_{AN}, which correspond to the values adopted for the three terms Q_{E0}, T_{E2} and T_{E0} of one particular piece of distillation apparatus. In the N stages, the representation f(T) of enthalpy fluxes of mass flow rates of water comprise two parallel straight lines having a slope Cp_{E}, separated by a number of degrees (T_{E2}−T_{E1}), and the representation f(T) of enthalpy fluxes of the air comprise, between these two straight lines, one single line formed festoons having successive extremities T_{A0C} to T_{ANC}, the mean slope of this line being slightly greater than that of these two straight lines. The relations between the extreme temperatures of the water and air are: (T_{E1}−T_{E0})=(T_{E2}−T_{E3})<(T_{ANC}−T_{A0C}).

To finish, we can note that, in view of the high thermal inertia of the various components of the apparatus, all the operations for implementing the method for maximizing performance of the first piece of distillation apparatus of a series can take several hours, this number of hours being itself directly proportional to the number N of stages.

Under these conditions, by carrying out the method according to the invention, experience has shown that with water distillation apparatus having four distillation stages, constructed in accordance with the invention, it is possible to obtain a coefficient of performance (CoP)>6, for a daily flow rate of distilled water produced which is equal to 3 to 5 times the total volume of the evaporation and condensation chambers of the apparatus.

According to the invention, the first model of a second type of improved water distillation apparatus having the general architecture of the new water distillation apparatus defined above and having N distillation units placed one above the other and forming two columns, one for evaporation and the other for condensation;

is characterized in that
these N distillation stages are separated from each other by (N−1) horizontal partitions;
two communication paths, one at an upper portion and one at a lower portion, are established between the vertical evaporation and condensation chambers of each distillation stage;
N variable-speed fans, notably achieved through the use of synchronous motors external of the condensation chambers have their blades installed in lower communication paths of the N distillation stages in order to produce N independent air streams respectively circulating in these N stages;
the sets of hollow components of the condensation chambers of these N distillation stages are connected together by tubes passing through these (N−1) horizontal partitions;
at an upper portion and a lower portion of the hydrophilic or wettable components of the evaporation chambers of the N distillation stages there are respectively installed means for distributing and spreading and for collecting the water circulating in the evaporation column, the means for distributing and spreading of evaporation chambers of ranks (N−1) to 1 being respectively fed by the collection means of the chambers of ranks N to 2.

According to the invention, the second model of this second type of improved water distillation apparatus having the general architecture of the new water distillation apparatus defined above, is characterized in that:
the N distillation units are juxtaposed;
two communication paths, one at an upper portion and one at a lower portion, are established between the vertical evaporation and condensation chambers of each distillation unit;
N fans having adjustable flow rates, notably through the use of synchronous motors external to the condensation chambers have their blades installed in lower communication paths of the N distillation units to produce N independent air streams respectively circulating in these N units;
the N hollow heat exchange devices of these N condensation chambers are interconnected by (N−1) thermally-insulated conduits;
the N sets of wettable or hydrophilic components of the N evaporation chambers include at an upper portion and lower portion of their respective ends, means for distributing and spreading and means for collecting water to be distilled;
(N−1) pumps and (N−1) thermally-insulated conduits are installed between the N evaporation chambers, for causing the water collected by the collection means of the distillation units of ranks N to 2, to be discharged into the means for distributing and spreading of the units of ranks (N−1) to 1.

According to the invention, a method to maximize performance of the first piece of apparatus of a series of one or the other of the two improved water distillation apparatuses of the second type, is characterized in that it includes the following additional steps:
adjust successively the N flow rates of air respectively produced by the N fans in order to generate at an upper portion of the N distillation units approximated predetermined optimal temperatures T_{A1} to T_{AN}, corresponding to the selected values Q_{E0} and T_{E2};
then, correct slightly these N flow rates to maximize T_{E1}, the temperature of the water leaving the heat exchanger of rank N, and display optimal setpoint temperatures T_{A1C} to T_{A4C};
read the final control settings for the N fans in order to notably make therefrom the specifications for series-production distillation apparatuses.

With these latter provisions, one can construct two particularly useful novel water distillation apparatuses adapted to treat water using fixed inlet parameters: mass flow rate Q_{E0} and high temperature value T_{E2}. Indeed, the N distillation units are substantially identical, except, however, that the rows of holes of the perforated trays are different from one apparatus to another and the N fan controls are set differently. Such water distillation apparatus employing juxtaposed distillation units is of considerable interest when daily production of distilled water is large (>10 m³/day). Indeed, it does make it possible to build distillation units which are identical, of medium height, easier to handle than multi-stage towers having the same number of distillation units.

In the case where both parameters Q_{E0} and T_{E2} are variable (solar energy), an interesting situation also exists. Indeed, as noted above, for any group of input parameters Q_{E0}, T_{E2}, T_{E0} and T_{A0}, as soon as temperatures T_{A1} to T_{AN} have been set, it is easy to calculate Q_{A1} to Q_{AN} as well as Q_{S1} to Q_{SN} and thus the operating conditions of the fans. When using fans with synchronous motors, one thus determines the frequencies F₁ to F_{N} of their supply voltages. This implementation of the method according to the invention, in order to maximize the performance of water distillation apparatus having N juxtaposed units, is particularly easy, using a computer and establishing correspondences between the frequencies F₁ to F_{N} and setpoint temperatures T_{A1C} to T_{ANC} to be obtained, as soon as the four values Q_{E0}, T_{E2}, T_{E0} and T_{A0} are input. To do this, an experimental database is set up, by performing at least three operations to get optimum settings for each of the four input parameters Q_{E0}, T_{E2}, T_{E0} and T_{A0}. Then we develop software that associates these data to the N optimal set point temperatures T_{A1C} to T_{ANC} and to the N frequencies F₁ to F_{N} of motor supply voltages. These frequencies will be determined by computer, from the values chosen for Q_{E0}, T_{E2}, T_{E0} and T_{A0}, and then manually or automatically adjusted.

In order to be able to properly dimension the evaporation and condensation chambers of the N distillation units of the different types of water distillation apparatus discussed above, according to the desired flow rate of distilled water from the apparatus to be constructed, it is necessary to determine their thermal conductance CT (watts per degree) and/or their thermal resistance RT (degrees per watt). To do this, they are calculated. This is done as a function of the respective components and architectures contemplated for construction of the two columns of the distillation apparatus. One then calculates the thermal conductance of an elementary slice of the evaporation and condensation chambers. These results are then integrated over the height of each of the two chambers of each one of the N distillation stages, in order to finally draw up charts for thermal conductance and resistances of the two columns. The accuracy of these calculations is estimated to be 10%. Having chosen the structures of the two columns, the next step is to respectively provide appropriate thermal resistances to the two chambers of the N distillation stages. This is done in accordance with equal enthalpy fluxes ΔH_{E} and ΔH_{A} to be exchanged in the two chambers of a given distillation stage. From one stage to another, these fluxes are, or are not, equal. The same applies to the thermal resistances of the two chambers of a distillation unit, in line with practical considerations imposed by the geometry of the apparatus.

The characteristics and advantages of the invention will become clearer from the following description, made with reference to the accompanying drawings in which:

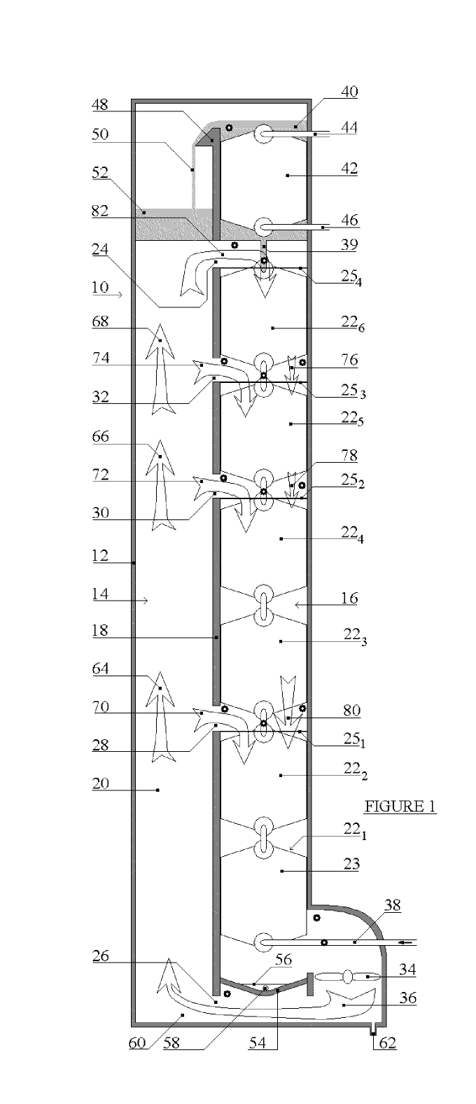

FIG. 1 is a diagram of water distillation apparatus with four distillation stages, notably for desalinating seawater;

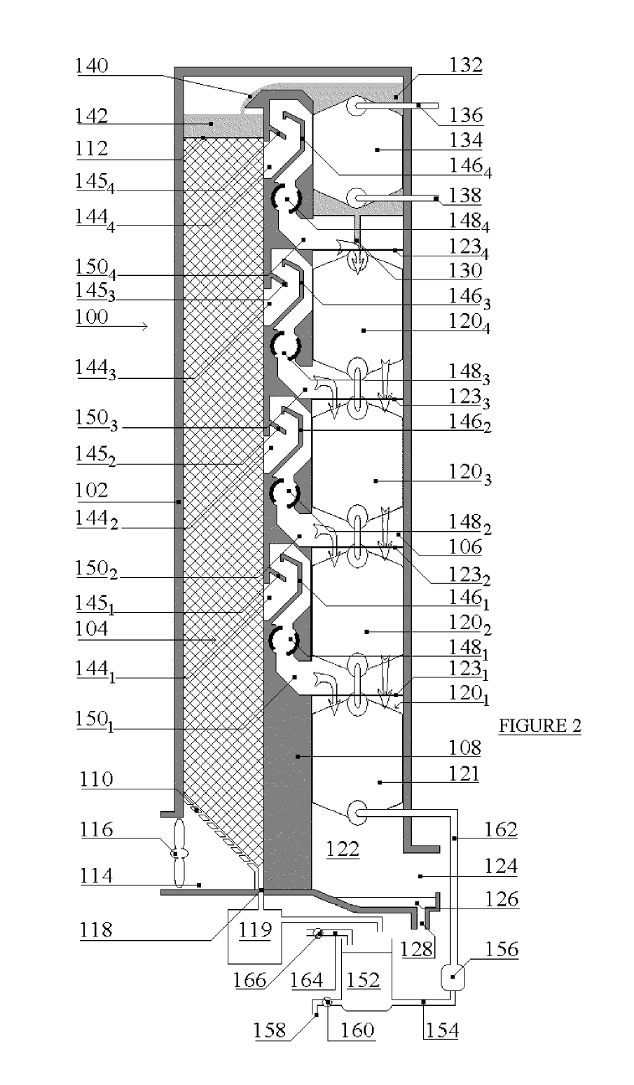

FIG. 2 is a diagram of similar water distillation apparatus for concentrating polluted process water;

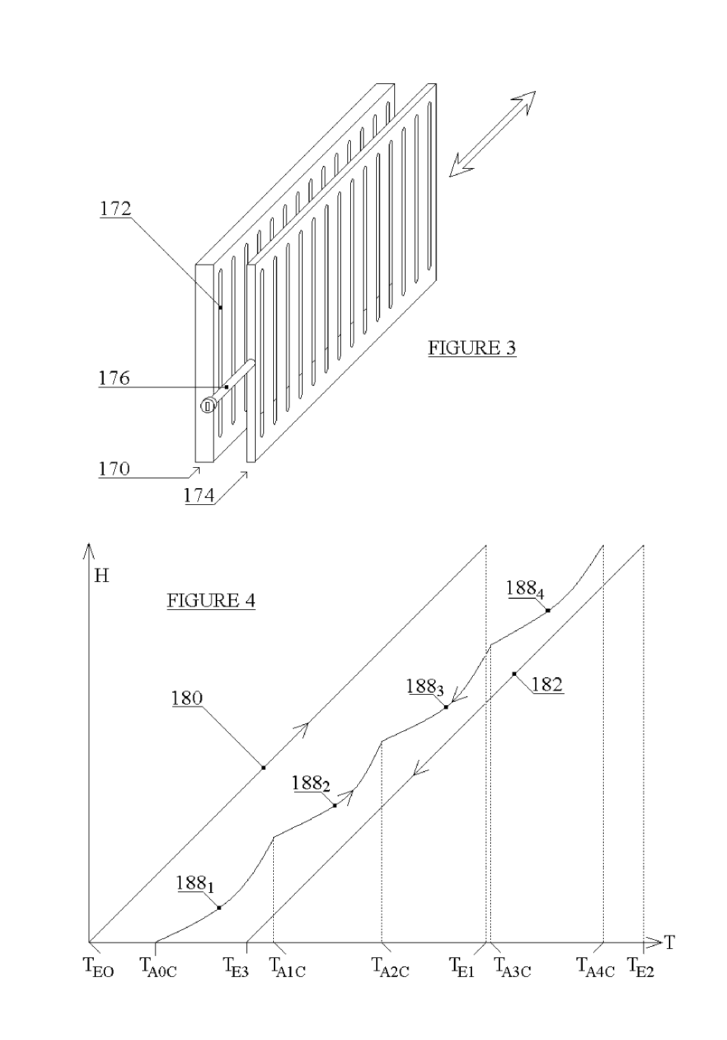

FIG. 3 shows the means for adjusting the effective cross-section of opening of a partition;

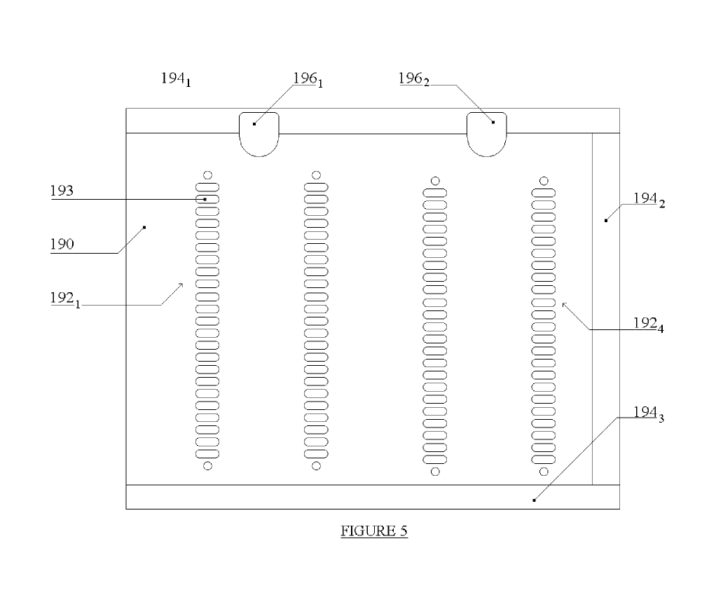

FIG. 4 shows curves for enthalpies of air and water circulating through water distillation apparatus according to the invention;

FIG. 5 shows a distribution plate for the air in the condensation chambers;

FIG. 6 is a diagram of water distillation apparatus with four juxtaposed distillation units according to the invention.

FIG. 1 shows schematically the first piece of apparatus of a series of seawater distillation apparatuses according to the invention. It consists of a tower 10, having insulating walls 12, 280 cm high, which includes two columns, one being evaporator column 14 and condensation column 16 being the other, separated by a partition 18 in polymer material. The set of components of evaporator column 14 is constituted by a juxtaposition of forty plates 20 in polymer, 2 mm thick, 240 cm high and 20 cm wide, arranged at a pitch of 15 mm. The total evaporation surface of the column 14 is 38.4 m² and its volume is 0.29 m³. The plates 20 are coated with a hydrophilic flocking, 0.5 mm thick, and they are juxtaposed vertically, the distance between the plates being 12 mm. The condensation column 16 is 240 cm high and it includes, connected in series by 5 cm tubes, six heat exchangers 22₁₋₆, 35 cm high and 20 wide, formed by juxtaposition at a constant pitch (10 mm), of forty rectangular hollow plates 23, installed vertically. These hollow plates 23 are blowmolded and have thin embossed walls (<1 mm) in polymer and an inner thickness of 3 mm, the distance between plates being 5 mm. The connection heads of these assembled hollow plates are welded to form the upstream and downstream manifolds of the heat exchanger so formed. These hollow plates and these heat exchangers are described in International Patent Application publication WO2011/145065 A1, filed by the applicant. Above each heat exchanger there is installed a distribution plate with a row of holes 25₁₄, adapted to equalize the partial air flows circulating between the hollow plates. A particular embodiment of such a plate is shown in FIG. 5. The total condensation surface of the column 16 is 29 m² and the total chamber volume is 0.19 m³.

The partition 18 is 240 cm high and includes two wide openings: one 24 at its top and the other 26 at its base. The partition 18 further includes three identical intermediate openings 28, 30 and 32, and each of these openings is a horizontal row of vertical slots, 10 cm high and 2 mm wide, having the same pitch (15 mm) as plates 20 of evaporation column 14. Such a row of slots is shown in FIG. 3. These three rows of slots have an effective cross-section which can be adjusted, thanks to the use of covers which are also shown in FIG. 3. The bottom of opening 32 is located 2 m from the floor of the column, and the bottoms of openings 30 and 28, at 1.6 m and 0.8 m therefrom. From this, the heights of the four distillation stages of tower 10 can be deduced. The two stages at the top of tower 10 each include a heat exchanger 22₆, 22₅ and the two bottom ones, two exchangers 22₄-22₃ and 22₂-22₁ each. Polymer conduits, which connect the manifolds of these heat exchangers 22₁₋₆ face the three openings 28, 30, 32 of the partition 18. The respective thermal resistances of the evaporation and condensation chambers of the four distillation stages, thus arranged in the tower 10 were calculated as described above.

The opening 26, arranged at the lower portion of the partition 18, is equipped with a fan 34 for drawing in air from the bottom of the condensation column 16 and propelling it upward in evaporation column 14 (arrow 36). The electric motor of the fan 34 is for example of the synchronous type and is powered by a variable frequency voltage. The graph giving the maximum flow rate and pressure of the air supplied by the fan 34, as a function of supply frequency, is available. The upstream manifold of heat exchanger 22₁ of condensation column 16 is connected by a polymeric conduit 38 to a storage tank providing it with seawater to be distilled, at an appropriate mass flow rate Q_{Eo}. This seawater constitutes the cold source of the apparatus. The downstream manifold of heat exchanger 22₆ of condensation column 16 is connected by a conduit 39 in polymer to the inlet of water heater 40, equipped with heating means, constituted by a heat exchanger 42, similar to exchangers 22₁₋₆. This exchanger 42 is supplied by two upstream and downstream pipes 44-46, in which a heat transfer fluid circulates, supplied by an external primary hot heat source (not shown). The water heater 40 has an outlet weir 48, from which hot seawater 50 trickles, entering a basin-like member 52. This basin-like member 52 has its bottom perforated with forty pairs of collared holes, corresponding to forty distribution troughs (not shown) covering an upper portions of the forty plates 20 of evaporation column 14. At the base of condensation column 16, there is installed a container 54 for collecting the distilled water 56; this container 54 is provided with walls in the form of a widely-opening V, and an evacuation conduit 58. Evaporation column 12 and tower 10 include, at their common base, a container 60 for collecting the concentrated seawater, this container 60 being provided with an evacuation conduit 62. Arrows 64-66-68 represent the ascending air streams in the evaporation column, and the arrows 70-72-74 show the air diverted through openings of the partition 18. The arrows 76-78-80 represent air streams descending down condensation column 16 and arrow 82, the stream entering the column 16, through opening 24 arranged at an upper portion of the partition 18.

In this first piece of apparatus 10 of a series of identical distillation apparatuses several thermocouples measuring the temperature T_{A1} to T_{A4} and T_{A1*} to T_{A4*} defined above, are installed at significant locations of the distillation apparatus; they are represented by black dots with a white center and are connected to a digital conversion circuit and display, not shown. Two thermocouples, respectively installed in hollow metal inserts sealingly fitted into holes through the wall of the inlet conduit 38 and outlet conduit 39 of condensation column 16 measure T_{E0} and T_{E1} and a third thermocouple in water heater 40 measures T_{E2}. Five thermocouples, respectively located in front of upper opening 24, lower opening 26, and intermediate openings 28, 30, 32 of the partition 18, measure T_{A0} and T_{A4}. Three more thermocouples, located respectively at the lower portion of heat exchangers 22₃, 22₅, 22₆ and adjacent the outer wall of the condensation column 16, measure T_{A1*}, T_{A2*}, and T_{A3*}. Three thermocouples, respectively fitted into metal inserts pass through the wall of the conduits connecting the heat exchangers 22₂-22₃, 22₄-22₅ and 22₅-22₆, measuring at intermediate openings 28, 30, 32, the temperatures of the water ascending in the condensation column.

FIG. 2 is a simplified representation, partially schematic, of the first piece of apparatus 100 of a series of identical water distillation apparatuses having four-stages according to the invention, adapted to concentrate industrial water (polluted effluent or food industry aqueous solutions). In order to produce a highly concentrated liquid, this distillation apparatus operates with water circulating in a closed circuit and air circulating in open circuit. The ambient air constitutes the cold source of the apparatus. According to FIG. 2, the water distillation apparatus 100 is enclosed in a cabinet which is 240 cm high, 100 cm wide and 50 cm deep and has an insulating outer wall 102, of polymer material foam, 10 cm thick. The distillation apparatus 100 has two columns, one being evaporation column 104 and the other condensation column 106, separated by a partition 108, 15 cm thick and 220 cm high. The evaporation column 104 has a square section of 25 cm side and includes an oblique bottom 110, perforated with openings of 1 cm diameter, staggered, with a distance separating them of 2 cm, a 3 cm strip at the bottom not being perforated. The outer face of bottom 110 is smooth and its inner face includes a 5 mm high collar around each opening. On the bottom 110 wettable artificial nuts are loosely stacked up to a level 112, near an upper portion of the partition 108. These nuts may be 12 mm long ceramic or plastic NOVALOX® saddles. Beneath oblique perforated bottom 110, there is a chamber 114 having a circular opening occupied by a fan 116, having adjustable air-flow, capable of producing an excess pressure of several hundred Pascals. In a lower imperforate strip of oblique bottom 110, the vertical portion of a conduit 118 for evacuation of concentrated aqueous solution discharges.

Condensation column 106 includes four heat exchangers 120₁₋₄, having hollow rectangular plates 121 and upstream-downstream manifolds, similar to the exchangers 22₁₋₆ of FIG. 1. These exchangers 120₁₄ are connected in series, with intervals of 5 cm between their manifolds, and above each heat exchanger there is installed a distribution plate having rows of holes 123₁₋₄, similar to the distribution plate 25₁₄ in FIG. 1 and the distribution plate 190 in FIG. 5. Underneath heat exchanger 120₁ there is provided a chamber 122 having a window 124, opening to the outside, and a concave bottom 126, with an evacuation conduit 128. The downstream manifold of heat exchanger 120₄ is connected, via a pipe 130, to the inlet of water heater 132, which is constantly filled with polluted water. In this water heater 132, there is fixedly mounted a heat exchanger 134, identical to heat exchangers 120₁₋₄. This heat exchanger 134 is provided with an upstream pipe 136 and a downstream pipe 138, connected to the outlet and to the inlet of an external heat source, which supplies the heat exchanger 134 with hot fluid at an appropriate temperature and flow rate. Water heater 132 is provided with a weir 140, by which hot water flows into a spreading basin-like member 142, resting on the top 112 of the stack of wettable artificial nuts filling the evaporation column 104. The bottom of basin-like member 142 is perforated with numerous holes having upstanding overflow collars, arranged in staggered fashion, these holes being 3 mm in diameter and 2 cm apart.

The partition 108 is of expanded polymer. The lowest portion of this partition 108 does not include any fittings and the remaining part thereof is occupied by four independent transit chambers 144₁₋₄, provided with elongated rectangular inlets, formed by rows of vertical slots, shown in FIG. 3. These slots have a width which is smaller than any dimension of the nuts packing evaporation column 104. The height of a lower edge portion of the row of slots upstream of the transit chamber 144₁ is 65 cm and those of a lower edge portions of the other rows of slots 144₂₋₄, are, respectively, 105, 145 and 185 cm. These heights are the heights of the ceilings of the evaporation chambers placed one on top of the other of column 104 of distillation apparatus 100.

As air streams, deviated by the inlets of the transit chambers 144₁₋₄, usually carry drops of industrial water, which is concentrated to a greater or lesser degree, these inlets include droplet separators, formed by baffles 145₁₋₄ and deflectors 146₁₋₄, which are hook-shaped, and co-operate to trap water droplets and bring them back into evaporation column 104. Beyond these baffles, lines are arranged leading to rotary valves 148₁₋₄ then to the intervals 150₁₋₄ which separate heat exchangers 120₁₋₄ and water heaters 132. Inside rotary valve 148₁₋₄, rotating cylinders, with diametrically opposed longitudinal openings (black in the figure) are equipped with manual control means, not shown. Rotary valve 148₄ is opened to the maximum and the pressure drop created by chamber 144₄ is negligible.

The conduit 118 for evacuating concentrated contaminated water produced by the distillation apparatus 100 is connected to a device 119 for natural cooling of the water, which discharges above a storage tank 152. This tank 152 has two outlet pipes, one of which 154, is connected to the inlet of a pump 156, and the other of which 158, is provided with a solenoid valve 160, for discharging this concentrated water to a industrial storage cistern. To close the loop of water circulation in the distillation apparatus 100, a pipe 162 connects the outlet of the pump 156 to the upstream manifold of heat exchanger 120₁ of condensation column 106. The industrial apparatus which is producing the polluted water to be concentrated is connected to the distillation apparatus 100 through a conduit 164 discharging above storage tank 152, this conduit being provided with a solenoid valve 166. Like the distillation apparatus 10 in FIG. 1, thermocouples which are not shown are installed at different points in distillation apparatus 100 in order to measure significant temperatures of air and water circulating therein.

When, in distillation apparatus 100 according to FIG. 2, industrial water circulates in a closed circuit and air in open or closed circuit to perform concentration of dissolved solids in the water, it is necessary to use a device for cooling 119, preferably natural cooling, to lower the maximum initial temperature T_{E3} of the concentrate to be discharged into the storage tank 152 and to make thereof one, or the, cold source of the apparatus. If this cooling is not sufficient for bringing the concentrate down to a temperature T_{E0} lower than the temperature T_{A0} of the air stream entering the evaporation column or a temperature T_{A0*} of the outgoing air stream from the condensation column, the coefficient of performance (CoP) of the distillation apparatus will be directly affected. The more the recycled concentrated liquid is cooled, the smaller will be the deterioration in CoP. Maximum natural cooling of this lukewarm concentrate can be obtained when it is discharged at an upper portion of a set of vertical supports, having hydrophilic or wettable surfaces, then cooled during its descent, by natural convection or forced convection of ambient air. When the dew point of the ambient air is sufficiently low, the final temperature T_{E0} of the liquid concentrate to be recycled is, as shown in FIG. 4, less than T_{A0}, the initial low temperature of the air injected at the foot of the evaporation column.

FIG. 3 shows a portion of a horizontal row 170 of vertical slots 172, formed in the partition 18 of the distillation apparatus 10 of FIG. 1 and at the inlet of a transit chamber 144₁₋₄ of the partition 108 of the distillation apparatus 100 of FIG. 2. This FIG. 3 also shows the sliding cover 174 disposed in front of each row of slots in the partition 18 of the distillation apparatus 10. These slots 172 are 10 cm high, 2 mm wide and have a pitch of 15 mm. The cover 174 includes a row of slots having a width identical to the width of the slots of the row 170 and, preferably, a height which decreases with the rank of the relevant distillation stage. This cover 174 is integral with a threaded shaft 176, rotatably mounted in a fixed nut, not shown.

FIG. 4 shows the curves H_{E}=f(T) for the enthalpy flux of the water circulating in open circuit, and the curves H_{A}=f(T) for the air circulating in closed circuit, in a distillation apparatus 10 in which all adjustments have been made correctly. The straight lines 180 and 182 respectively represent enthalpy fluxes, increasing and decreasing, of the streams of rising cold water and descending hot water. These straight lines are parallel and their slope is Cp_{E}. The temperatures at the ends of these two lines 180-182 are respectively T_{E0}, T_{E1}, T_{E2}, and T_{E3}. Curve 184 represents both the enthalpy flux of streams of rising and falling saturated damp hot air circulating in distillation apparatus 10. Curve 184 has four festoons which depart from a straight line, 188₁₋₄, corresponding to the four stages of distillation of apparatus 10. The temperatures at the ends of these festoons 188₁₋₄ are respectively T_{A0c}, T_{A1C}, T_{A2c}, T_{A3C} and T_{A4C}. Between successive sections of the festoons 188₁₋₄ and the two rising and falling straight lines 180 and, respectively, 182, the horizontal distances between them are representative of the various apparent thermal resistances of the corresponding sections of evaporation column 14 and condensation column 16 of the distillation apparatus.

FIG. 5 shows a perforated tray 190, made of polymer material, surmounting one of the condensation chambers of the water distillation apparatus according to the invention. The heat exchanger of this chamber is formed by the juxtaposition and the putting in parallel of two identical devices having 24 hollow plates, 20 cm wide assembled on a 10 mm pitch with 5 mm spacings. Perforated tray 190 is 40 cm long, 33 cm wide and 3 mm thick; it includes four rows 192₁₋₄, each with 25 holes separated by 10 cm intervals. Each row has 23 oblong holes, such as oblong hole 193, these being 6 mm wide and 12 mm long, with at the end two round holes, 6 mm in diameter. The oblong holes 193 are arranged above spaces separating the hollow plates and the round holes arranged above the spaces between the end plates and the walls of the condensation chamber. The perforated tray 190 has three edge portions 194₁₋₃, 30 mm thick and 50 mm high, to seal the air duct between two condensation chambers located one on top of the other, and two apertures 196₁₋₂ to enable sealed passage of the two tubes providing connection between the two heat exchangers of each condensation chamber.

In discussing operation of the first piece of apparatus 10 or 100 of one or the other of the two series-production distillation apparatuses concerned, it is considered that distillation apparatus 100 is, initially, virtually simplified and arranged to operate in the same way as distillation apparatus 10. The fundamental data are the mass flow rate Q_{E0} of water that is spread and distributed and water temperatures T_{E0}, T_{E2} and air temperature T_{A0}. For example, Q_{E}o=100 g/s and T_{E2}=85° C., for both pieces of apparatus. As distillation apparatuses 10 and 100 both operate with closed loop air streams and open loop water streams, then we have T_{E0}=20° C. and then T_{A0}=27° C. and T_{A4}=83° C. From these data, we can carry out the adjustment procedure described in detail above for the fan and the cross-sections of the openings in the partition. We start by determining the temperatures of the air streams we need to establish at the rows of slots 28, 30, 32 of partition 18 of the distillation apparatus 10 and the similar rows of partition 108 of the distillation apparatus 100. With extreme temperatures of 27 and 83° C., we will have successively (approximately) 45, 61, and 73° C. and local steps of substantially 18, 16, 12 and 10° C. Next, we spread and distribute hot water, for a fairly long period to bring the components of each piece of apparatus to a suitable temperature, and then turn on the fan 34 or 116. As evaporation column 16 is provided with vertical plates, having wettable or hydrophilic surfaces juxtaposed on a constant pitch and column 104 having wettable artificial nuts loosely packed, the passages offered to air streams and the pressure drops therein are very different. Under these conditions, the same thing applies to the excess pressure of the air to be produced by the fans: from 100 to 200 Pascals for the fan 34 of the distillation apparatus 10, and from 300 to 500 Pascals for fan 116 of distillation apparatus 100. Indeed, in the distillation apparatus 10, the ascending air streams have uniform velocities and are unlikely to be carrying water droplets, which enables the rows of vertical slots 24, 26, 28, 32 to directly open into the condensation column 16. However, the same thing does not apply in the distillation apparatus 100, since here the air streams can have significant local velocities carrying along droplets of water and brine, notably in the row of slots arranged upstream of the entrance to transit chamber 141₁ of the distillation stage of rank 1 These carried-along drops of water and brine necessitate the presence of droplet separators 145₁₋₄-146₁₋₄, that trap and return them to the evaporation chambers.

The flow rates of the fans 34 or 116 are adjusted to temporarily bring the temperature T_{A1} of the air passing through the row of slots of rank 1 of partitions 18 or 108 of distillation apparatuses 10 and 100 to 45° C. Then, using the covers 174 or rotary valves 148₁₋₃ we adjust the port cross-sectional area of the openings 18 of the partition concerned of the distillation apparatus 10 or those of the partition 108 of the distillation apparatus 100 to have temperatures T_{A2}=61° C. and then T_{A3}=73° C., at the tops of the evaporation chambers of ranks 2 and 3. Then we re-adjust the settings of covers 174 or rotary valves 148 of rank n, so that the temperature T_{An} at the entrance to the evaporation chamber of rank n becomes equal to the temperature T_{An*} at the outlet of the condensation chamber of the same rank. These temperatures then constitute optimal setpoints T_{A1C}, T_{A2C} and T_{A3C}, which only differ from the initial temperatures by a difference <1 5° C. After this, we slightly correct the speed of the fan to maximize the temperature T_{E1} of the water at the outlet of the condensation column and to bring it as close as possible to T_{E2}, up to T_{E1}=0.75° C. for example.

Having done this, container 54 or 126 receives an amount of 40 liters per hour of distilled water and with the values given above for T_{E0}, T_{E1} and T_{E2}, the coefficient of performance (CoP)=6.5. The thermal power supplied to the apparatus by the water heater is P_{ch}=3.8 kW and that used in distillation P_{Dist}=24.7 kW, whereby the apparent overall thermal conductance of the evaporation and condensation columns of the distillation apparatus 10 or 100 is given by CT=P_{Dist}/(T_{E2}−T_{E1})=2470 W/K.

Then, the values of the settings of the controls of fans 34 and 116 are noted as are the settings for the port cross-sectional area of the communication paths between chambers of the distillation units and these values are used as constructional specifications for series production apparatus. This will be frequency for the synchronous motors of the fans and values, accurate to one-tenth of a millimeter, for the four rows of vertical slots of the apparatus 10 and the horizontal slots of the four partitions replacing the valves which have been adjusted of apparatus 100. As for the dimensions of the holes in distribution plates 25₁₄ and 123₁₄, these are calculated for each condensation chamber, as a function of approximated volumetric flow rates of saturated damp hot air Q_{S1} to Q_{S4} circulating in these four chambers.

The thus constructed water distillation apparatuses are designed to operate with inlet parameters Q_{E0} and T_{E2} which are constant. As long as this is so, the coefficient of performance (CoP) of the apparatus is at a maximum, but when for any reason the value of one and/or the other of these parameters deviates somewhat from its initial value, the overall performance of the distillation apparatus is moderately lowered while nevertheless remaining satisfactory.

In the case of a simplified distillation apparatus 10 or distillation apparatus 100, both treating seawater or brackish water, notably fossil, the distilled water is collected and converted into drinking water, by adding appropriate mineral salts, while seawater with a low salt concentration is directly discharged into the sea.

In the case of the distillation apparatus 100 described, operating to produce a concentrate of industrial water, the air stream circulates in an open or a closed loop and the water stream in a closed loop. The concentrate, pre-cooled in device 119 (which becomes the sole cold source when the air circulates in a closed loop) is collected in tank 152 and is recycled until its concentration is sufficient. To do this, the contaminated water, becoming progressively concentrated in the tank 152, is drawn in by the pump 156 and injected into the manifold upstream of heat exchanger 120₁ of condensation column 106. When this concentration is sufficient, pump 156 is stopped, the solenoid valve 160 for emptying the tank 152 is operated and a given volume of process water, highly concentrated (5-10 times), is stored in a remote cistern, awaiting collection. At the end of this operation, a fresh volume of industrial water is poured into the storage tank 152 by actuating the solenoid valve 166 for an appropriate period of time. Following this, pump 156 is restarted. The cycle of these operations is determined by trial, depending on the efficiency of the apparatus; solenoid valves 160 and 166 and pump 156 are controlled cyclically, by a programmed controller. The cost of getting rid of a concentrate of polluted water is reduced in correspondence with the degree of concentration achieved. For its part, the distilled water can be collected for local use or rejected into nature. Making use of the same supplementary subassemblies, a distillation apparatus 10, having an evaporation column fitted with evaporation plates with wettable surfaces can be converted into apparatus to produce a concentrate of industrial waste water. And, vice versa, distillation apparatus 100 can be used to produce distilled water and highly concentrated brine.

FIG. 6 shows at A a diagram of water distillation apparatus 200 formed by four juxtaposed distillation units in front view, 202, 204, 206 and 208, similar to the distillation stages of FIGS. 1-2, having respectively ranks of 4, 3, 2 and 1. At B, FIG. 6 gives a schematic view of the distillation unit 208, seen in section C-C.

In each of the evaporation chambers of these units, there are arranged vertically, at a constant pitch of 15 mm, one-hundred non-metallic plates 210 having wettable surfaces as a result of the presence of suitable reliefs, 6 mm thick, 80 cm wide and 125 high cm. The total surface area for exchange of the plates is 200 m² and the volume of an evaporation chamber is 1.5 m³. In each of the condensation chambers, the heat exchanger 212 is of the same type as those in FIGS. 1 and 2 (hollow blow molded plates with upstream and downstream welded manifolds). Each heat exchanger 212 comprises one hundred and fifty hollow vertical plates 213, 80 cm wide and 125 cm high, assembled on a pitch of 10 mm. The total surface area for heat exchange of the plates is 300 m² and the volume of each condensation chamber is 1.5 m³. The upstream coupling 214 of the heat exchanger 212 of the coolest unit 208 is connected to a connection point 216 for supplying seawater at ambient temperature (20° C.) and at an appropriate excess pressure. The downstream coupling 218 of this heat exchanger 212 is connected to a heat-insulated conduit 220 which leads to the upstream coupling of the heat exchanger of distillation unit 206. The same applies to the units 204 and 202 in which the thermally-insulated conduits 222 and 224 connect the downstream coupling of the first of these to the upstream coupling of the heat exchanger of the second one of these. The downstream connection of the heat exchanger of the hottest unit 202 is connected to the inlet of a water heater 226 the outlet of which is connected to a basin-like member 228 feeding the individual spreading and distribution troughs (not shown) for the wettable plates 210. The floor of the evaporation chamber of unit 202 is arranged so as to form a container 230 for collecting seawater, having increased salt content, which is running from its wettable plates 210. In this container 230 there is installed a pump 232 connected by a thermally-insulated conduit 234 to the basin-like member 236 of the distributing and spreading device of unit 206 which includes a collection container 238 and a pump 240. This pump 240 is connected by a thermally-insulated conduit 242 to the container 244 of the distributing device of the unit 206, which includes a collection bin 246 and a pump 248. This pump 248 is connected by a thermally-insulated conduit 250 to the basin-like member 252 of the distributing device of unit 208, which includes a collection bin 254 provided with an evacuation conduit 256. Just like the preceding ones, the basin-like member 252, shown at B of FIG. 5, is provided with one hundred pairs of overflow weirs 253 a-b, feeding the distributing and spreading troughs of the one hundred plates 210. On FIG. 5B, above the condensation chambers there are arranged distribution plates having rows of holes 257, similar to the distribution plates 25 and 123 of FIGS. 1 and 2. In a lower opening formed in a partition 258 separating the evaporation and condensation chambers of unit 208, fan blades 260 are mounted, connected by a shaft 262 to the synchronous motor for a fan. This motor together with its variable-frequency power supply unit are represented by block 264, external of the condensation chamber. This block includes either a manual control provided with a dial 266, or automatic control driven by computer. The four units 202, 204, 206 and 200 are fitted with similar internal fan blades 260₁₋₄ and external motor units 264₁₋₄. The power of these motors and/or the pitch of the fan blades are adapted to the operating conditions of each unit. The arrows 265 and 267 show the direction of closed-circuit circulation of the air currents produced by the fans. The distilled water is collected in a bin 268 installed at the foot of each condensation chamber. All these bins are connected to an evacuation pipe 270. Temperature continuity between the juxtaposed distillation units is assured by the rising or descending stream of water passing from one unit to the other.

This distillation apparatus having four juxtaposed distillation units is well suited to large quantities of daily production of distilled water. With a power for water heater 226 of 120 kW and a mass flow rate Q_{E}o of 4.5 kg/s of water to be distilled, daily production is around 30 m³/day for the distillation apparatus 200. In addition the latter is notably well suited to situations in which the amount of thermal energy available is variable notably over the course of one day, thereby imposing mass water flow rates which more or less follow the same trends. In this case, a computer with the appropriate software defined above, supplies the adjustments for the motor blocks, once the parameters Q_{E0}, T_{E2}, T_{E0} and T_{A0} have been entered. These settings are then made in two possible ways: (1) read on the computer screen values for the setpoints of the dials associated with the controls for these four frequencies, and manually display these values on the dials or (2) program the computer to directly set the control means to these four frequencies.

The modifications to be introduced into the distillation apparatuses 10 and 100 using distillation units placed one above the other shown in FIGS. 1 and 2 in order to transform them into pieces of apparatus in which the currents of air in the distillation stages are independent of each other are obvious from the very definitions of these pieces of apparatus. Between four stages, which are more or less identical to the one of rank 1 on these two figures, these will be horizontal partitions through which pipes connecting heat exchangers one to the other pass, supplemented, in each stage, by means for collecting and for spreading and distributing the water to be distilled, identical to those in FIG. 6. There is little point in providing a diagram illustrating the water distillation apparatus according to FIG. 1 or 2 fitted with such everyday supplementary equipment. Further, it can be useful to combine these two embodiments and to constitute groups formed of two distillation units placed one above the other, and then to juxtapose these groups. This is suitable for medium-height (<120 cm) distillation units that can be easily stacked without causing any particular problems in handling.

The invention is not limited to the embodiments described with reference to FIGS. 1, 2 and 6.

Indeed, the components of the evaporation and condensation chambers can be different from those presented (plates having hydrophilic or wettable faces, wettable nuts in ceramic or polymer material). In all cases, these components will be non-metallic in order to avoid problems of corrosion and too high cost. Regarding the evaporation chambers, these can be any thin planar support, notably formed by a stretched woven hydrophilic sheet, or yet again, artificial nuts of baked clay. Regarding the condensation chambers, one can use heat exchangers which are formed by commercially-available alveolar plates provided with primary manifolds, connected to secondary upstream and downstream manifolds. In distillation apparatus 200, using juxtaposed distillation units, the evaporation chambers can be filled with wettable artificial nuts and communications between the pair of chambers of each unit can include droplet separators. In addition to standard distillation apparatus which is manufactured pre-set, apparatus which is identical to a first one of each series, including the majority of the measurement and adjusting means can obviously be put on the market in order to satisfy individual customers.

1. Water distillation apparatus using saturated damp hot air streams with recovery of latent heat of condensation, of the kind in which:
a number N of distillation units is provided, the unit of rank 1 being the least hot and the one of rank N being the hottest;
each of these N distillation units includes a pair of vertical chambers, one for the evaporation of water and the other for vapor condensation, communicating at an upper portion;
each of the N evaporation chambers N is occupied by a set of wettable or hydrophilic components;
each of the N condensation chambers is occupied by a hollow heat exchanger device, these N devices being connected in series;
means are connected to the apparatus to provide a water stream, at a mass flow rate Q_{E0}, at a low initial temperature T_{E0}, to cause the water stream to flow upwardly in the N hollow heat exchange devices;
a water heater is connected to the outlet of the N hollow heat exchange devices, to bring the stream of water exiting therefrom at a temperature T_{E1} to a high temperature value T_{E2} lower than 100° C.,
means are installed in the apparatus to spread the hot water at a temperature T_{E2}, at an upper portion of the components of the evaporation chamber of rank N and to cause it to trickle down the components of evaporation chambers of ranks N−1 to 1;
means are installed in the apparatus for forcing N adjusted saturated damp hot air flow rates to circulate upwardly in the N evaporation chambers and downwardly in the N condensation chambers so as to respectively bring the N streams of air, circulating at an upper portion of the evaporation chambers, up to predetermined temperatures T_{A1} to T_{AN};
means for collecting distilled water flow rates are installed at a lower portion of the condensation chamber of rank 1;
means for collecting flow rates of concentrated aqueous solution are installed at a lower portion of the evaporation chamber of rank 1;
wherein:
the N heat exchange devices have cross-sections and heights that are substantially identical to those of the N condensation chambers;
these N heat exchange devices are groups of hollow polymer plates assembled so as to be separated at a constant pitch, each group being provided with upstream and downstream manifolds;
in the N condensation chambers, the hollow plates are installed vertically.

2. The water distillation apparatus, according to claim 1, wherein it includes N perforated trays adapted to distribute total flow rates of air, entering respectively into the N condensation chambers, into substantially equal partial air flow rates penetrating into the spaces between the hollow plates of these chambers.

3. The water distillation apparatus, according to claim 1, wherein, in each of the N distillation units:
communication between the evaporation and condensation chambers includes a horizontal elongated rectangular window;
the cross-section of the condensation chamber, perforated tray and hollow plates is rectangular;
the perforated tray is installed without significant edge portion leakage and has rows of holes, surmounting all the hollow plates;
said holes are oblong and are formed at the same pitch as that at which the plates are assembled, their width being substantially equal to that of the spaces between the plates.

4. The water distillation apparatus, according to claim 1, of the type in which:
the N distillation units are located one on top of the other, forming two evaporation and condensation columns;
a fan is installed at a lower portion of the evaporation column;
wherein
the N evaporation chambers include thin planar supports, having wettable or hydrophilic surfaces installed vertically at a constant pitch;
the N communication paths between pairs of chambers are N horizontal rows of vertical slots, with the preceding pitch, formed in a partition separating the two chambers, with or without N sliding covers associated with these N communication paths, and temperature sensors, installed at the respective outlets of the evaporation and condensation chambers;
either the apparatus is designed to be adjusted at the site of its operation and, for this purpose, includes the said manual adjustment means and the fan has variable speed control, the apparatus being designed to be operated according to the method defined in claim 11 hereinafter;
or the apparatus is preset,
the fan control is non-variable as are the respective cross-sections of these N rows of slots, the settings of this control and of these cross-sections having been established in accordance with design specifications arising from final manual adjustment of the first piece of apparatus of a series of identical water distillation apparatuses performed according to said method.

5. The water distillation apparatus, according to claim 1, of the type in which:
the N distillation units are located one on top of the other, forming two evaporation and condensation columns;
the N evaporation chambers are filled with artificial nuts which are wettable, loosely packed,
a fan is installed at a lower portion of the evaporation column;
wherein:
the N communication paths between the pairs of chambers are ducts of rectangular elongate section, having upstream a perforated horizontal area, adapted to retain said nuts and to allow air to pass, and having downstream, said horizontal elongated rectangular window;
in each of these N ducts, there is installed a droplet separator, arranged immediately downstream of each one of the N perforated areas, and either a partition with a horizontally elongated rectangular slot, or an adjustable rotary valve;
in the case where the apparatus is designed to be adjusted on its site of operation, according to the method set out in claim 11 hereinafter, temperature sensors are installed at the respective outlets of the evaporation and condensation chambers, the fan as well as the N adjustable rotary valves being manually controlled;
in the case where the apparatus is preset and the speed of the fan as well as the widths of these N slots of the partitions are non-adjustable, the values thereof have been established in accordance with constructional specifications resulting from manual adjustments of the first piece of apparatus of a series of identical distillation apparatuses
carried out according to said method.

6. The water distillation apparatus according to claim 1, of the type wherein the N distillation units are located one on top of the other and form two columns, one for evaporation and the other for condensation;
wherein
these N distillation stages are separated from each other by N−1 horizontal partitions;
two communication paths, one at an upper portion and one at a lower portion, are established between the vertical evaporation and condensation chambers of each distillation stage;
N fixed or variable-speed fans, notably achieved through the use of synchronous motors external of the condensation chambers have their blades installed in lower communication paths of the N distillation stages in order to produce N independent air streams respectively circulating in these N stages;
the sets of hollow components of the condensation chambers of these N distillation stages are connected together by tubes passing through these N−1 horizontal partitions;
at an upper portion and a lower portion of the hydrophilic or wettable components of the evaporation chambers of the N distillation stages there are respectively installed means for distributing and spreading and for collecting the water circulating in the evaporation column, the means for distributing and spreading of evaporation chambers of ranks N−1 to 1 being respectively fed by the collection means of the chambers of ranks N to 2.

7. The water distillation apparatus (200) according to claim 1, characterized in that wherein:
the N distillation units are juxtaposed;
two communication paths, one at an upper portion and one at a lower portion, are established between the vertical evaporation and condensation chambers of each distillation unit;
N fans having fixed or adjustable flow rates, notably through the use of synchronous motors external to the condensation chambers, have their blades installed in lower communication paths of the N distillation units, to produce N independent air streams respectively circulating in these N units;
the N hollow heat exchange devices of these N condensation chambers are interconnected by N−1 thermally-insulated conduits;
the N sets of hydrophilic or wettable components, of the N evaporation chambers, include at an upper portion and lower portion of their respective ends, means for distributing and spreading and means for collecting water to be distilled;
N−1 pumps and N−1 thermally-insulated conduits are installed between the N evaporation chambers, for causing the water collected by the collection means of the distillation units of ranks N to 2, to be discharged into the means for distributing and spreading of the units of ranks N−1 to 1.

8. The water distillation apparatus according to claim 6 or 7, wherein the number of distillation units being an even number, the apparatus is constituted by juxtaposed groups each comprising two units located one on top of the other.

9. The water distillation apparatus according to claim 6 or 7, wherein with the evaporation chamber of each distillation unit being packed with wettable artificial nuts, a droplet separator is installed in the communication path established between upper portions of the evaporation chamber and the condensation chamber.

10. The water distillation apparatus, according to claim 4, comprising apparatus for concentrating industrial water, wherein it includes:
a first conduit for recovering the concentrated aqueous solution, flowing at a lower portion of the evaporation chamber of rank 1, this conduit supplying a natural cooling device terminating at an upper portion of a storage tank;
a pump for drawing in the contents of the storage tank and injecting it at a lower portion of the hollow components of the condensation chamber of rank 1, in order to cause a stream of concentrated aqueous solution to circulate in a closed loop in the apparatus;
a second conduit to ensure continuous evacuation, for the recovery or disposal, of the amount of distilled water produced;
a third conduit associated with a first solenoid valve to evacuate with a view to recovery, the volume of concentrated aqueous solution contained in the storage tank;
a fourth conduit associated with a second solenoid valve for replacing the contents of the storage tank by a new volume of process water;
the two solenoid valves operate according to a period determined by the efficiency of the apparatus.

11. A method for maximizing the performance of a water distillation apparatus, according to claim 3, wherein, it includes the following preliminary steps:
(1) depending on the conditions of use of said distillation apparatus, select an apparatus having a number N of distillation stages which is at least 3 and a maximum of 6, determined as a direct function of the values of the differences T_{E2}−T_{E0} or T_{AN}−T_{A0} between the extreme temperatures of the air or water, the number N=4 being suitable for all cases;
(2) on the basis of a saturated damp hot air enthalpy curve, select N approximated optimal predetermined temperatures T_{A1} to T_{AN}, which the saturated damp hot air streams at an upper portion of the N evaporation chambers should adopt, so that the said N air flows include N festoons having deflections of substantially equal amplitudes, lower than 1.5° C.;
(3) select an appropriate value for the mass flow rate Q_{E0} of the water to treated and a high temperature value T_{E2} lower than 90° for this water;
(4) read the initial low temperatures of the air T_{A0} and of the water T_{E0};
(5) calculate the N approximated mass flow rates of dry air Q_{A1} to Q_{AN} and then the N approximated volume flow rates of saturated damp hot air Q_{S1} to Q_{SN} which it is respectively necessary to cause to circulate in the N distillation units of the apparatus in order to obtain said approximated optimal temperatures T_{A1} to T_{AN} and in order to finalize the specifications of the apparatus.

12. A method for maximizing the performance of the water distillation apparatus wherein having N distillation stages each comprising two chambers, one for distillation and the other for evaporation communicating at upper portions thereof, said method being of the type including the following initial steps:
by means of a fan, cause a volume flow rate of saturated damp hot air Q_{S1} to circulate in open or closed loop in the distillation stage of rank 1, to raise the temperature of this stream of air, at an upper portion of the evaporation chamber of rank 1, at a predetermined value T_{A1};
successively adjust the adjustable flow cross-sections of the communication paths established between the evaporation and condensation chambers of the distillation stages of ranks 1 to N−1, to respectively bring the temperatures of the air streams at an upper portion of the evaporation chambers of distillation stages of ranks 2 to N, to predetermined values T_{A2} to T_{AN};
wherein
this method only applies to the water distillation apparatus according to claims 3 and 4;
it includes the preliminary adjustment method according to claim 11, in order to determine an appropriate number N of distillation stages and in order to calculate approximated optimal values for predetermined temperatures T_{A1} to T_{AN} and includes the following supplementary steps:
maximize the temperature T_{E1} of the water leaving the condensation column, (a) by making respectively equal the temperatures T_{A1} to T_{A(N-1)} of the saturated damp hot air streams, entering the evaporation chambers of distillation stages of ranks 2 to N, and the mean temperatures T_{A1*} to T_{AN)*} of the saturated hot damp air streams leaving the condensation chambers of these same distillation stages, by means of slight correction of the previously adjusted port cross-sectional area of the three communication paths; and (b) by readjusting the air flow rate previously produced by the fan, in particular by a small correction of a frequency of the supply voltage of the motor, when it is of the synchronous type;
in the case of the first piece of apparatus of a series of identical water distillation apparatuses, read the final setting of the fan and the final dimensions of each of the N port cross-sectional area of the communication paths between the chambers of each of the N distillation stages in order to notably make therefrom the specifications for series-production distillation apparatuses.

13. The method according to claim 11 to maximize the performance either of the first piece of apparatus of a series of identical water distillation apparatuses, according to claim 6 or 7 or any apparatus of this type which is to be adjusted at the site it will be used at, wherein it includes the following additional steps:
adjust successively the N volumetric flow rates of saturated hot damp air Q_{S1} to Q_{SN}, respectively produced by the N fans in order to generate at an upper portion of the N distillation units approximated predetermined optimal temperatures T_{A1} to T_{AN};
correct slightly these N flow rates to maximize T_{E1}, the temperature of the water leaving the heat exchanger of rank N, in order to determine optimal setpoint temperatures T_{A1C} to T_{AN};
in the case of a said first piece of apparatus, read the final control settings for the N fans in order to notably make therefrom the specifications for series-production distillation apparatuses.

14. Software for controlling water distillation apparatus according to claim 4, equipped with synchronous motor fan, the said distillation apparatus being required to be capable of treating water at a mass flow rate Q_{E0} and high temperature value T_{E2}, both likely to vary between two determined extreme values, low values for water temperatures T_{E0} and air temperature T_{A0} requiring to be read at the site of use;
wherein it includes:
a database, created in accordance with the method defined in claim 13, associating groups of setpoint temperatures T_{A1C} to T_{ANC} with groups of frequencies F₁ to F_{N} of supply voltages to the synchronous motors of the N fans, in response to at least three possible values for each of four input parameter Q_{E0}, T_{E2}, T_{E0} and T_{A0} of the distillation apparatus;
a main program P1, associated with this database, for calculating, from possible values for Q_{E0}, T_{E2}, T_{E0} and T_{A0}, N temperatures T_{A1C} to T_{ANC} and N frequencies F₁ to F_{N}, corresponding to operator-selected values for these four parameters;
either a supplementary program P2 to display on a screen the setpoint values of the N dials associated with manual controls for these N frequencies;
or a supplementary program P2* to directly set automatic controls for the N frequencies.

15. The water distillation apparatus according to claim 6 or 7 wherein:
when the apparatus is the first piece of apparatus of a series of identical distillation apparatuses or when the apparatus is intended to be adjusted on its site of operation, the N fans have adjustable flow rates and temperature sensors are installed in the upper-portion communication paths between the two chambers of the N distillation units, adjustment of this piece of apparatus being performed according to the method defined in claim 13 hereinafter;
when the piece of apparatus is factory pre-set, the N fans have fixed flow rates, determined by their relative constructional specifications, resulting from carrying out the steps of said method on the first distillation apparatus of the series.
